(19) United States
(12) Patent Application Publication
(10) Pub. No.: US 2025/0367608 A1
(43) Pub. Date: Dec. 4, 2025

(54) COATINGS FOR FIELD FLOW FRACTIONATION CHANNELS TO REDUCE SAMPLE STICKING

(71) Applicant: Wyatt Technology, LLC, Goleta, CA (US)

(72) Inventors: Fraser McLeod, Goleta, CA (US); Steven P. Trainoff, Santa Barbara, CA (US); Anthony Clemens, Goleta, CA (US)

(21) Appl. No.: 19/223,753

(22) Filed: May 30, 2025

Related U.S. Application Data
(60) Provisional application No. 63/654,498, filed on May 31, 2024.

(51) Int. Cl. B01D 69/10

(52) U.S. Cl. CPC B01D 69/10; B01D 2323/2185; B01D 2325/30

(57) ABSTRACT

A separation mechanism comprises a top plate; a base parallel the top plate; a membrane between the top plate and the base; a channel formed by the top plate and the base; and a low-bind coating at a surface of at least one of the top plate or the membrane along which a sample stream in a flow path flows through the channel to reduce or prevent analyte particles of the sample stream from sticking to the top plate.

### RELATED APPLICATION

This application claims priority to U.S. provisional patent application No. 63/654,498 filed May 31, 2024 and titled “Coatings for Field Flow Fractionation Channels to Reduce Sample Sticking,” the contents of which are incorporated by reference in their entirety.

### FIELD

The present disclosure relates to field flow fractionation (FFF) separation techniques, and more specifically, to techniques for coating FFF channels to reduce sample sticking.

### BACKGROUND

A common problem with Asymmetric Flow Field Flow Fractionation (AF4) systems is imperfect mass recovery, which can reduce the sensitivity of the technique. Mass recovery is measured by injecting a known mass into a FFF channel and measuring the total mass of the fractionated components. Ideally, 100% of the sample that is injected will be recovered. However, in practice some of the sample can be lost during fractionation. There are several possible loss mechanisms. Some samples such as some nucleotides are sticky and tend to adhere to metallic components in the FFF channel, such as the top surface or the separation membrane. Some components can pass through the fractionation membrane and end up in the waste stream. Portions of a sample may get trapped in the corners of the channel and slowly release over time. Even though they are not technically lost, they will not be properly measured by integrating the detector signal. Lastly, sample can be poorly retained on the membrane and lost through a dilution control system of the separation system. Accordingly, non-specific binding of molecules within a FFF channel can negatively impact the ability to detect and accurately quantify these molecules.

### SUMMARY

In one aspect, a separation mechanism comprises a top plate; a base parallel the top plate; a membrane between the top plate and the base; a channel formed by the top plate and the membrane; and a low-bind coating at a surface of the top plate along which a sample stream in a flow path flows through the channel to reduce or prevent analyte particles of the sample stream from sticking to the top plate. In some embodiments, the channel is a variable height channel, which includes a spacer that sets the thickness of the channel and defines its horizontal shape of the channel. In other embodiments, the channel is a fixed height, wherein the channel is machined into the top plate and the top plate directly abuts the base in the absence of a spacer.

In another aspect, a separation mechanism comprises a top plate; a base parallel the top plate; a membrane between the top plate and the base; a channel formed by the top plate and the membrane; and a low-bind coating at a surface of the membrane along which a sample stream in a flow path flows through the channel.

In another aspect, a method of separating and analyzing a sample comprises injecting the sample into a separation mechanism, wherein the separation system comprises a channel formed by a metallic surface including a low-bind coating on the metallic surface; flowing a sample stream through the channel; separating the sample, wherein the low-bind coating reduces or prevents analyte particles of the sample stream from sticking to the metallic surface forming the channel; and analyzing the separated sample stream by outputting the separated sample stream to a detector.

In another aspect, a field flow fractionization system comprises an injector; and a separation channel having an input coupled to the injector and an output coupled to a detector, the separation channel further comprising: a top plate; a base parallel the top plate; a membrane between the top plate and the base; a channel formed by the top plate and the base; and a low-bind coating at a surface of the top plate along which a sample stream in a flow path flows through the channel to reduce or prevent analyte particles of the sample stream from sticking to the top plate.

### BRIEF DESCRIPTION OF THE DRAWINGS

FIG. 1A is a schematic illustration of a 4-port separation mechanism in a FFF channel, in which embodiments of the present inventive concept can be practiced.

FIG. 1B is a schematic illustration of a 5-port separation mechanism in an FFF channel, in which embodiments of the present inventive concept can be practiced.

FIG. 2-6 are graphical illustrations of a conventional problem of sticky samples exhibiting mass loss.

FIG. 7 is an enlarged view of a channel of a separation mechanism according to an embodiment of the present inventive concept.

FIG. 8 is a graph of a mass loss in a conventional FFF channel compared to a mass loss in an FFF channel according to embodiments of the present inventive concept.

### DETAILED DESCRIPTION

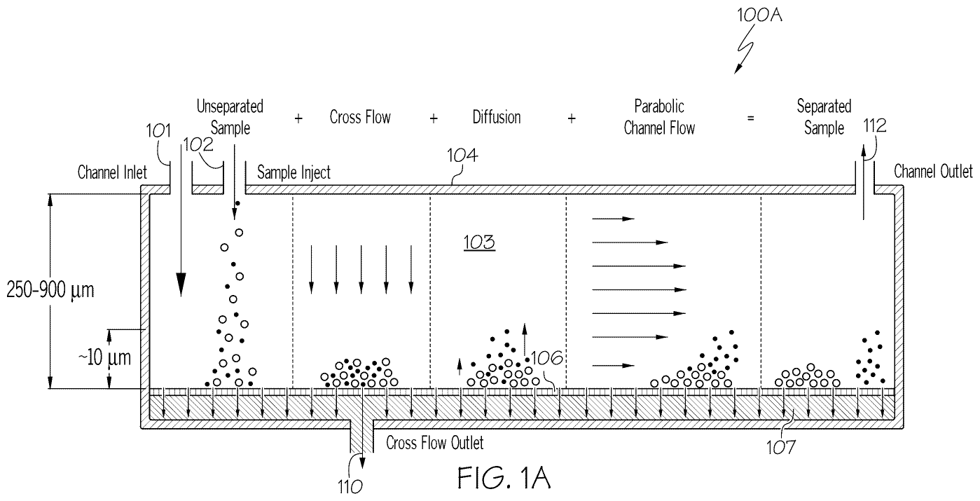

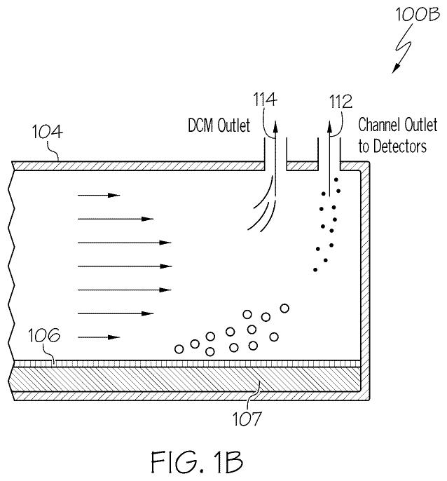

FIG. 1A is a schematic illustration of a 4-port separation mechanism 100A, in which embodiments of the present inventive concept can be practiced. FIG. 1B is a schematic illustration of a 5-port separation mechanism 100B, in which embodiments of the present inventive concept can be practiced. The separation mechanism 100A and 100B (generally, 100) is constructed and arranged to separate and characterize nano-and microparticles in a sample. In some embodiments, the 4-port or 5-port separation mechanism 100A, 100B (generally, 100) can perform an asymmetric-flow field-flow fractionation (AF4) separation process or the like. The separation process requires three states: injection, focus, and elution, each described in detail below.

As shown in FIGS. 1A and 1B, solvent is injected into a channel inlet port 101. Sample is injected through a sample inject port 102. The separation mechanism 100 includes a channel 103 between a top plate 104 and a semi-permeable membrane 106 supported by a frit 107. The membrane is permeable to solvent but not to analytes. The particle-containing carrier fluid flows parallel to the membrane 106. Some of the carrier fluid passes through the membrane, creating a “flow field” that concentrates the particles towards the membrane, and more specifically, causes the sample to concentrate near the membrane surface, as shown in the cross flow region of the channel. The solvent that has passed through the membrane is collected through a cross flow outlet 110. As is explained below, different fractions travel down the channel at different rates causing them to separate with the small fractions arriving first followed by progressively large fractions.

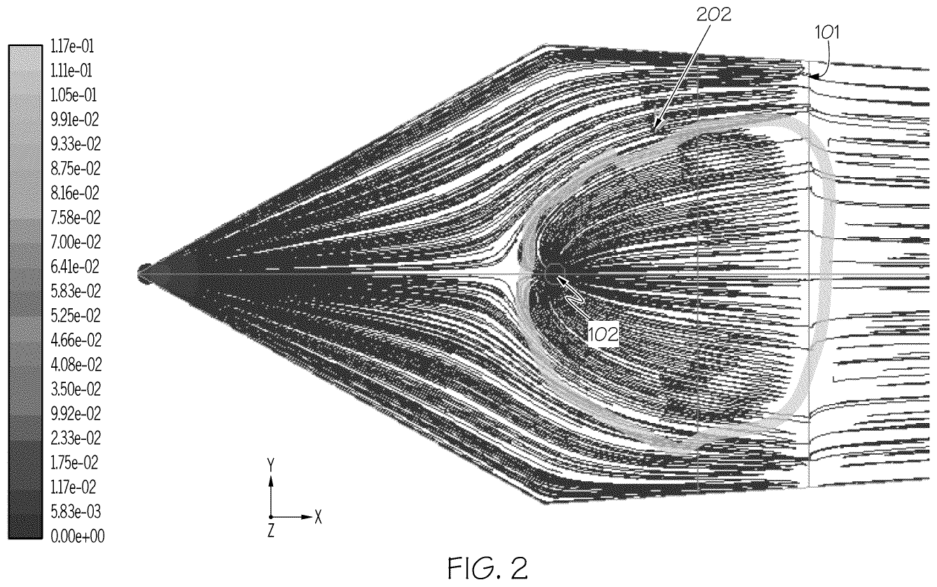

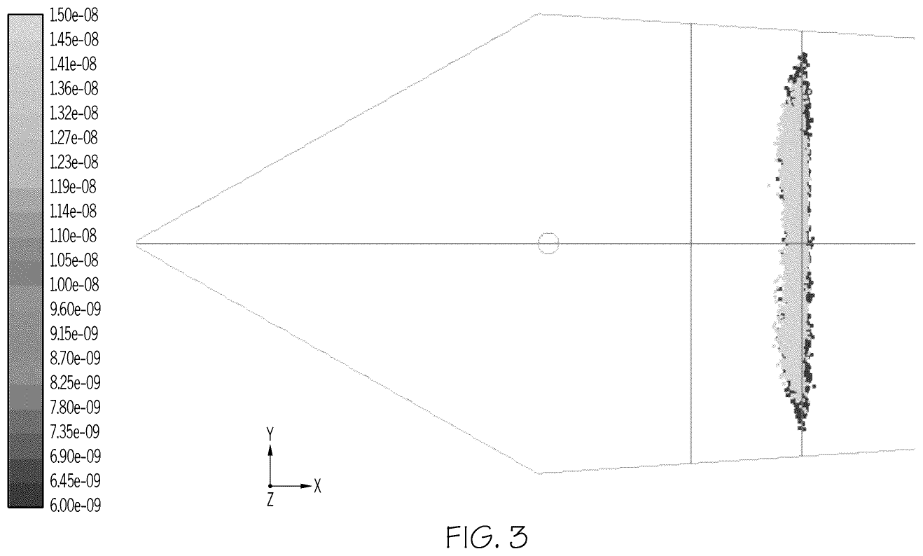

When the sample is injected into the channel 103 it spreads out into an extended blob as seen in the center of FIG. 2. It is then focused into a thin band and concentrated towards the membrane. The position of that band depends on the ratio of flow rates from the inlet and outlet ports-higher flow from the inlet port moves the focus position downstream, shown for example in FIG. 3.

Once the system is sufficiently focused, the flows are valved into an elution state so that the sample stream travels down the channel between the walls of the channel. The fractions travel at different rates and exit through the channel outlet port 112 where they are analyzed by a series of detectors or collected by a fraction collector. For example, a detector can detect the presence of an analyte, e.g., ions, molecules, and so on or changes detected by the sample flowing through the detector. When the sample is collected in the channel outlet port 112, it is diluted with the solvent in the upper part of the channel 103.

As shown in FIG. 1B, an optional secondary flow, which consists of sample-free solvent, can exit through a dilution control module (DCM) port 114. During fractionation, the sample is constrained to be with a few micrometers of the membrane surface. The rest of the channel is filled with sample-free solvent. When the sample is collected at the outlet port, both the sample and the sample-free solvent are mixed, resulting in a large dilution. By having an extra port (DCM) 114, some of the sample-free solvent can be removed. The result is that sample collected in the outlet port has a higher concentration. By removing some of the solvent, the dilution of the sample can be reduced. One possible loss sample mechanism is for some of the sample to inadvertently exit via the DCM port 114 with the solvent. Experiments with low binding samples show that sample loss though via this mechanism is insignificant. Another possibility is that the sample may interact with the membrane 106, and stick to its surface. Finally, sample may stick on the top plate 104, which can contribute to non-trivial mass loss. The subject of this application is to address this last mechanism.

In brief overview, embodiments of the present inventive concept include an application of coatings to the plates of an FFF channel, e.g., shown in FIGS. 1A and 1B, so that a sample does not bind to the low-binding or non-stick surface of the coating to mitigate the problem of sticky samples exhibiting substantial mass loss in the flow path of the channel. In some embodiments, the channel is a variable height channel that uses a spacer to define the horizontal shape of the channel. Here, one can change the height of the channel and thereby the separation performance) by changing spacers. In other embodiments, the channel is a fixed height channel in which the separation channel is machined into the top plate. It has no spacer so it is not as configurable, but it is much easier to use and has much better reproducibility.

In other embodiments, the channel is a dispersion inlet (DI) channel that uses hydrodynamic relaxation to inject the sample and drive it towards the separation membrane without the need for focusing. DI channels, commonly referred to as a “frit inlet” channels, are also amenable to non-stick surface treatments,. Coating techniques described in embodiments herein can equally well apply to DI channels.

Referring to FIG. 2, the sample is injected when the system is in the focus-inject state. In this state solvent enters the channel from both the channel inlet port 101, and the channel outlet ports 112 and exits through the membrane 106. Simultaneously sample laden fluid is injected through the injection port 102. The solvent flows through the support frit 107 and is collected by the cross flow outlet port 110. The sample forms a region 202 referred to as a “blob” as shown in FIG. 2. This blob 202 fills the full vertical extent of the channel from the membrane 106 to the top plate 104. It is during this step that sample, in contact with the top plate 104, can stick. Next the injection flow is stopped so that the system is in the focus state. For a typical experiment, while focusing, the ratio of inlet to outlet flows is set to approximately 25:75, so that there is a line near the inlet 101 where the x component of the flow vanishes. This is the focus line. Then the sample blob 202 as viewed from the top shown in FIG. 2, migrates and accumulates on the focus line as shown in FIG. 3. The focus state serves two purposes. It moves the sample in the x and y directions (as view from the top) so that it focuses a line as viewed from the top as shown in FIG. 3. It also relaxes the sample in the z direction so that it accumulates near the membrane surface. Any material that is stuck to the top surface during 104 during injection is lost from the subsequent fractionation. In equilibrium, the flux downward provided by the flow field is balanced by a counteracting flux upwards due to diffusion. As is well known, the equilibrium concentration profile is an exponential function with a maximum on the membrane surface and decays exponentially as a function of height above the membrane. For a typical channel that is 350 μm thick, the exponential decay length is typically <10 μm, which is a small fraction of the channel thickness. In essence, once the sample is fully relaxed, it is constrained to a thin layer near the membrane surface 106 and is protected from interacting with the top plate 104 by a layer of solvent. If the sample is prone to sticking to the walls of channel 103 it is only during the injection and early during the focusing process when it is likely to occur.

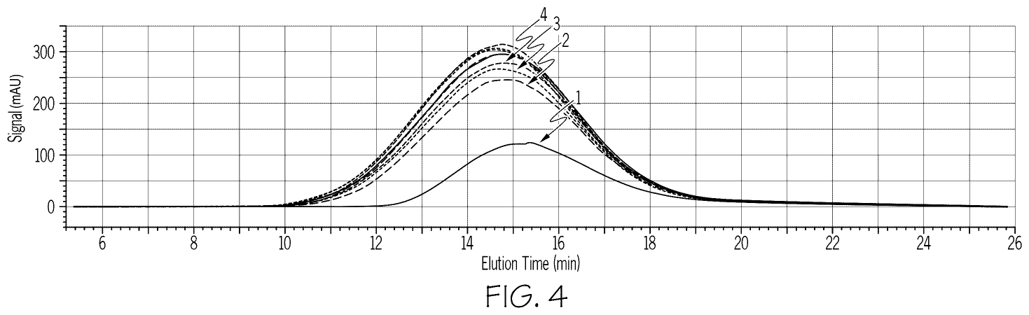

To characterize where and how much of the sample is lost to various surfaces, the following protocol was used. First the system was assembled with a new or fresh membrane and flushed with mobile phase used for the subsequent fractionalization. A sticky sample was repeatedly injected and fractionated by the channel. The sticky sample used in these experiments included 60 nm carboxylate modified latex (CML) particles (Invitrogen #C37233), which had previously been observed to show mass loss in FFF channels. After the elution, a UV absorption detector operated at 250 nm was used to measure how much sample was eluted. To determine the mass recovery, the area of the UV peak was computed, and normalized by the area of a reference peak, which is the last peak in the series, after the area has reached an asymptote at a constant value. FIG. 4 shows an example of a typical data series from a freshly prepared channel. The injections performed in this experiment are illustrated by curves (1)-(4). In this experiment, channel 103 or more specifically, the walls including the top plate 104, were fabricated of type II titanium but not limited thereto so the top plate 104 may be formed of different or additional materials. As shown in FIG. 4, injection (1) is much lower in amplitude than subsequent injections (2)-(4), indicating that the sticking process saturates over time.

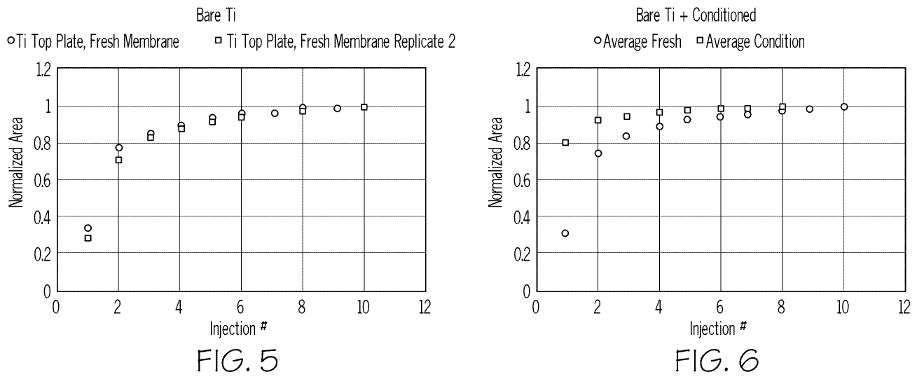

FIG. 5 shows the recovered mass calculations for two replicate sequences, where the last injection (#10) was used for normalization. The first injection after the system is assembled is around 30% of the tenth injection, showing that roughly 70% of the sample is lost. The replicate sequences show that the effect is reproducible.

The question remains whether the sample is lost due to sticking to the separation membrane 106 or to the top plate 104 of channel 103. To address this question, a new experiment was performed. If the sample sticks primarily to the membrane, then after the ten injections, it would be saturated with the sample, which is why the area calculation asymptotes to a constant. If one opens the channel and cleans the top plate 104, while reusing the conditioned membrane, one expects no additional mass loss. If, on the other hand, the sample sticks to the top plate 104, then this procedure would again result in measurable mass loss. The result is shown in FIG. 6. The circle points are the average of two runs in which the system was thoroughly cleaned, and a new membrane was used (average of the two runs in FIG. 5). The square points are the average of two runs with conditioned membranes.

These experiments show that after the conditioning process, the first injection only loses 20% of the mass. This implies that of the original 70% loss, 50% of can be attributed to sticking to the membrane, and 20% to sticking to the top plate 104. This illustrates that the portion of mass loss due to sample sticking to the top plate 104 of the FFF channel is nontrivial, if not dominant.

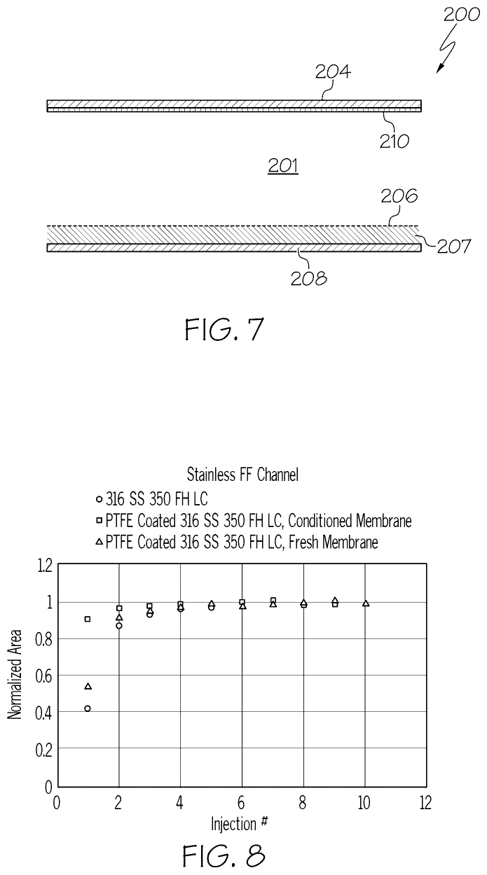

FIG. 7 is an enlarged view of channel 201 of a separation mechanism 200 according to an embodiment of the present inventive concept. The separation mechanism 200 can be part of an FFF instrument. Accordingly, the separation mechanism may include pumps for generating an eluent flow followed by a sample injector at an input of the separation mechanism 200 and one or more detectors, e.g., a spectrometer but not limited thereto, at an output of the separation mechanism 200.

The separation mechanism 200 is formed by top plate 204 and a base 208. A membrane 206 and frit 207 can extend along a length of the channel. The channel 201 extends between the top plate 204 and the membrane 206, and can have a width thickness that permits a sample separation to be performed, for example, 200 μm-900 μm, but not limited thereto. The sample molecules of varying types and sizes, for example, ranging in size on the order of nanometer to microns.

In some embodiments, the top plate 204 is constructed of stainless steel, for example, 316 stainless steel. In other embodiments, the top plate 204 includes titanium or related metal or alloy. In other embodiments, non-metallic materials may be used. In some embodiments, the top plate 204 includes a coating or layer 210 of non-stick material. In other embodiments, the top plate 204 is constructed of a non-stick material that provide the same or similar features as the non-stick coating 210. In some embodiments, the non-stick coating 210 may be a hydrophobic coating such as a fluoropolymer, for example, polytetrafluoroethylene (PTFE). The presence of the coating 210 permits the separation mechanism 200 mitigate the problem shown and described in FIGS. 2-6, namely, reducing the mass loss associated with the nontrivial mass lost due to sample sticking to the top plate 204.

FIG. 8 is a graphical illustration of a comparison between an uncoated top plate and the top plate 204 coated with the non-stick material 210 shown in FIG. 7.

The uncoated stainless steel top plate (grey) showed a mass loss of 58% on the first injection, which is less than the 70% loss observed in the previous experiment with the Ti top plate. This demonstrates that the composition of the top plate affects sample sticking. The more salient point is that the PTFE coated top plate reduced this to a mass loss of 46% relative to the 58% loss for the uncoated plate (a difference of 12%). Similarly, the PTFE coated top plate 204 with a conditioned membrane had a mass loss of only 9%, which is consistent with the improvement seen between the coated and uncoated fresh membrane runs. The conclusion is that coating the top plate 204 can mitigate the mass loss associated with sticking to the plate 204 by roughly a factor of two.

In conclusion, the foregoing experiments were conducted with CMLs that are known to be sticky. This provides a stringent test of varying the channel surface chemistry. These experiments demonstrate that for this test case, most of the sticking can be attributed to the membrane, but sticking to the channel surfaces, especially the top plate, is nontrivial and can be reduced by using different construction materials (Ti or SS) or coating them with non-stick coatings such as PTFE or alternative coatings having better non-stick performance for specific applications. In this case, the lost mass fraction with a conditioned membrane dropped from nearly 20% to 9%. Other coatings may improve this further. A viable candidate coating is the two-carbon polyethylene glycol (C2/PEG) coating. Finally, one could functionalize the membrane itself to further improve mass recovery.

Accordingly, the application of non-stick coatings to the FFF channel, or more specifically, the top plate and/or the membrane, in accordance with embodiments of the present inventive concept improves the mass recovery of sticky samples because the sample does not bind to the low-binding surface of the coating. Improvement was demonstrated with a low or non-bind coating such as PTFE coating, although other low-bind, non-stick, or non-bind coatings may be application specific. Further improvement is likely from functionalizing the membranes since they currently account for most of the mass loss. For example, alkyl silyl, organosilicon, or hydrophilic, and/or non-ionic coating layer comprising a polyethylene glycol silane may equally apply, but not limited thereto.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A separation mechanism, comprising:
a top plate;
a base parallel to the top plate;
a membrane between the top plate and the base;
a channel formed by the top plate and the base; and
a low-bind coating at a surface of the top plate along which a sample stream in a flow path flows through the channel to reduce or prevent analyte particles of the sample stream from sticking to the top plate.

2. The separation mechanism of claim 1, wherein the separation mechanism includes an output to a detection system, wherein the low-bind coating reduces mass loss and increases mass recovery of the analyte particles in the sample stream for output to the detection system.

3. The separation mechanism of claim 2, wherein the mass loss changes a composition of the sample.

4. The separation mechanism of claim 1, wherein the separation mechanism is constructed and arranged as a field flow fractionator.

5. The separation mechanism of claim 4, wherein the field flow fractionator performs Flow Field Flow Fractionation (AF4).

6. The separation mechanism of claim 1, wherein the low-bind coating includes a non-stick material comprising polytetrafluoroethylene (PTFE).

7. The separation mechanism of claim 1, wherein the low-bind coating includes a non-stick material comprising two-carbon polyethylene glycol (C2/PEG).

8. The separation mechanism of claim 1, wherein the channel is a fixed height channel.

9. The separation mechanism of claim 1, wherein the channel is a variable height channel.

10. The separation mechanism of claim 1, wherein the channel is a dispersion inlet channel.

11. A separation mechanism, comprising:
a top plate;
a base parallel to the top plate;
a membrane between the top plate and the base;
a channel formed by the top plate and the base; and
a low-bind coating at a surface of the membrane along which a sample stream in a flow path flows through the channel.

12. The separation mechanism of claim 11, wherein the separation mechanism includes an output to a detection system, wherein the low-bind coating reduces mass loss and increases mass recovery of the analyte particles in the sample stream for output to the detection system.

13. The separation mechanism of claim 12, wherein the mass loss changes a composition of the sample.

14. The separation mechanism of claim 11, wherein the separation mechanism is constructed and arranged as a field flow fractionator.

15. The separation mechanism of claim 14, wherein the field flow fractionator performs Flow Field Flow Fractionation (AF4).

16. The separation mechanism of claim 11, wherein the low-bind coating includes a non-stick material comprising polytetrafluoroethylene (PTFE).

17. The separation mechanism of claim 11, wherein the low-bind coating includes a non-stick material comprising two-carbon polyethylene glycol (C2/PEG).

18. The separation mechanism of claim 11, wherein the channel is a fixed height channel.

19. The separation mechanism of claim 11, wherein the channel is a variable height channel.

20. A field flow fractionization system, comprising:
an injector; and
a separation channel having an input coupled to the injector and an output coupled to a detector, the separation channel further comprising:
a top plate;
a base parallel to the top plate;
a membrane between the top plate and the base;
a channel formed by the top plate and the base; and
a low-bind coating at a surface of at least one of the top plate or the membrane along which a sample stream in a flow path flows through the channel to reduce or prevent analyte particles of the sample stream from sticking to the top plate.
